(19) United States
(12) Patent Application Publication
(10) Pub. No.: US 2014/0305939 A1
(43) Pub. Date: Oct. 16, 2014

(54) MULTILAYER PACKAGING STRUCTURE

(71) Applicants: Stéphane Mathieu, Publier (FR); Joachim Pellissier, Fully (CH)

(72) Inventors: Stéphane Mathieu, Publier (FR); Joachim Pellissier, Fully (CH)

(73) Assignee: AISAPACK HOLDING S.A., Vouvry (CH)

(21) Appl. No.: 14/111,906

(22) PCT Filed: Apr. 13, 2012
(86) PCT No.: PCT/IB2012/051816

§ 371 Date: Dec. 9, 2013

(30) Foreign Application Priority Data
Apr. 15, 2011 (EP) 11162559.6

(51) Int. Cl. B32B 27/08; B32B 27/32

(52) U.S. Cl. CPC B32B 27/08; B32B 27/32
USPC 220/62.11; 428/516; 428/36.6; 138/103

(57) ABSTRACT

The invention relates to a multilayer structure produced by moulding and intended to form at least one part of the packaging wall, said structure comprising an oxygen barrier layer, referred to as a “passive layer”, composed of a resin that is a barrier to oxygen, and another layer, referred to as to an “active layer”, composed of at least one resin that is permeable to oxygen and in which oxygen absorbers are dispersed. The invention also relates to packaging comprising said multilayer structure.

### FIELD OF THE INVENTION

The invention relates to the field of packaging, and, more particularly, to that of the multilayer structures forming at least a part of the wall of a package.

### STATE OF THE ART

Many products degrade when they are in contact with oxygen molecules. The packaged products can come into contact with the oxygen for two main reasons.

The first reason is linked to the air captive in the package at the time of the packaging operation when the product does not completely fill the cavity of the container. The second is linked to the migration through the wall of the packaging of the oxygen molecules present in the ambient air.

A number of approaches have been proposed to mitigate these difficulties, such as substituting the air captive in the package with an inert gas, like the use of multilayer structures or like the use of oxygen absorbers that are captive in the wall of the package.

There are numerous packagings or parts of packagings which are manufactured by injection molding or by compression molding. Improving the barrier properties of these molded packages has been the subject of numerous developments in recent years. The patent applications WO2007111857 and WO2008096290 describe improving the molded objects by multilayer injection or compression.

The development of oxygen absorbers has made it possible, in some cases, to replace the more complex multilayer structures to be manufactured with single-layer packaging walls comprising oxygen absorbers.

However, this solution can be used only when the conservation time of the product is time-reduced.

Unlike the packagings manufactured from films for which it is possible to obtain an almost total oxygen barrier—that is to say, for example, when the structure comprises an aluminum film—it is not possible today to obtain as high a barrier level for packages or parts of packages manufactured by injection or compression molding.

Some packagings comprise only a part that is molded. Such is the case, for example, of the flexible tubes for which the head is manufactured by molding. These packagings exhibit an oxygen permeability that is generally higher in the molded part despite the efforts made to improve the barrier properties. These packagings also exhibit a greatly reduced oxygen impermeability at the area of transition between the molded part and the film forming the flexible part. For these reasons, it is difficult to use packagings comprising a molded part to conserve products that are very sensitive to oxygen or to conserve products that degrade with oxygen for a long period.

### EXPLANATION OF THE INVENTION

The object of the invention is to remedy the abovementioned problems using a significant improvement of the oxygen barrier properties of the molded packagings.

The invention consists of a multilayer structure having a very weak oxygen permeability through an unexpected synergy between at least one passive barrier layer and one active barrier layer. A “passive barrier layer” is defined as a layer of oxygen barrier resin having a weak oxygen permeability and an “active barrier layer” is defined as a layer of oxygen permeable resin comprising oxygen absorbers.

The invention results from a synergy between the passive and active barrier layers as well as their relative position in the multilayer structure.

The invention also makes it possible to significantly improve the oxygen impermeability of packagings comprising a molded part linked to a flexible part composed of films.

Hereinafter in the explanation, multilayer structures obtained by molding are presented. In order to simplify their understanding, the same convention will always be used, consisting in describing the multilayer structure from the outer surface of the packaging which is generally the visible part, to the inner surface of the packaging which is in contact with the packaged product. The following references will be used for clarity of the explanation:
1: passive oxygen barrier layer
2: active oxygen barrier layer
3: oxygen permeable layer

The invention consists in using at least two distinct resins for which the oxygen permeability ratio is greater than or equal to 50. The first resin with the lower oxygen permeability forms the passive oxygen barrier layer 1. Oxygen absorbers are dispersed in the second resin for which the oxygen permeability is at least 50 times greater and forms the active oxygen barrier layer 2. The association of the layers 1 and 2 results in considerably improved conservation times.

The invention also consists in producing a multilayer structure by injection or compression molding, said structure comprising at least one passive barrier layer and one active barrier layer; the active barrier layer being situated between the passive barrier layer and the packaged product.

In order to better understand the unexpected effect of the invention, let us consider the following three examples:

### EXAMPLE 1

Take a multilayer structure of overall thickness denoted E forming a package. The multilayer structure is composed of a first, strongly oxygen permeable resin and a second resin with oxygen permeability at least 50 times lower and forming a thin passive barrier layer denoted Ep. This multilayer structure leads to a product conservation time denoted Dp. It is known to those skilled in the art that, by doubling the thickness of the passive barrier layer, or by adding a second passive barrier layer of identical thickness, the product conservation time is roughly doubled.

### EXAMPLE 2

Take the packaging considered in example 1 in which the wall of thickness E is composed only of said first, strongly oxygen permeable resin containing 15% oxygen absorber. The conservation time of said product in this packaging is denoted Da. It is also known to those skilled in the art that by doubling the quantity of oxygen absorber in the wall of packaging the product conservation time is roughly doubled.

### EXAMPLE 3

The third example illustrates the unexpected effect of the invention. Take the packaging considered in the examples 1 and 2 in which the wall of thickness E is composed of said first, strongly permeable resin and containing 15% oxygen absorbers and said second resin forming a passive barrier layer of thickness Ep. The product conservation time in the packaging is very much greater than the sum of Dp and Da.

A first embodiment of the invention consists of a multilayer structure comprising an active barrier layer and a passive barrier layer.

A second embodiment of the invention consists of a structure comprising at least one active barrier layer 2 captive between two passive barrier layers 1; said active barrier layer 2 being composed of oxygen absorbers dispersed in a first resin and the passive barrier layer 1 being composed of a second resin of oxygen permeability at least 50 times lower than that of said first resin.

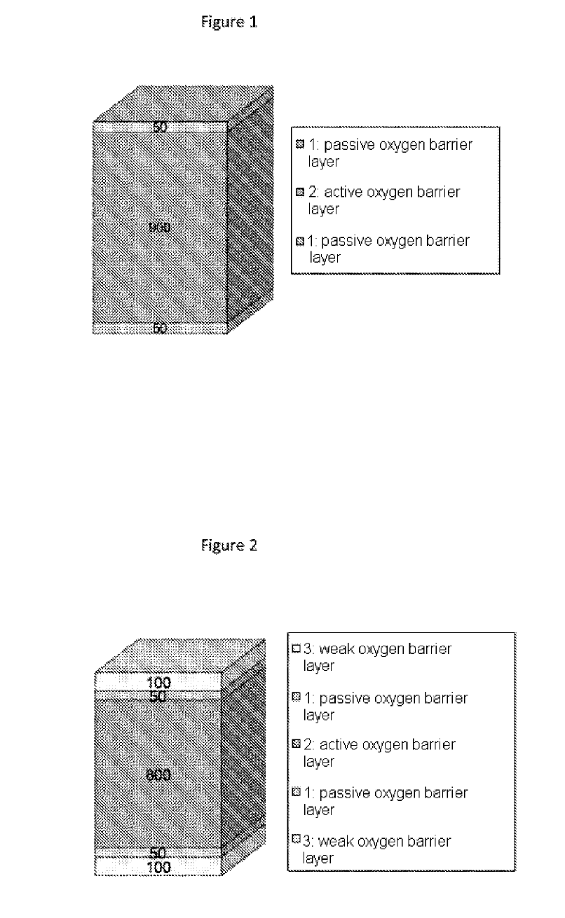

A fourth example relating to the first embodiment of the invention is illustrated in FIG. 1 and consists of a structure comprising, in succession, the layers 1/2/1. The fact of having the active layer 2 captive between two passive layers 1 makes it possible to avoid any interactions between the packaged product and the oxygen absorbers. In some cases, an alteration of the appearance of the packaging is observed when the oxygen absorbers are used in the layer forming the surface of the packaging (change of coloring). This first exemplary embodiment makes it possible to avoid this difficulty and makes it possible to obtain packaging of high visual quality, with no alteration of the color over time. The layer 1 is, for example, an amorphous polyamide PA6I/6T exhibiting a weak oxygen permeability in a moist environment. The layer 2 is composed, for example, of oxygen absorbers dispersed in polypropylene. The oxygen absorbers are, for example: Amosor, Celox, Shelfplus, or any other reference generally developed for PET or polyolefin applications.

A fifth example relative to the first embodiment of the invention is illustrated in FIG. 2 and consists of a structure comprising the successive layers 3/1/2/1/3. The neutral layers 3 forming the outer and inner surfaces of the packaging are made of an oxygen permeable resin. A “neutral layer” is defined as a layer composed of a resin whose oxygen permeability is greater than 100 cm³O₂*μm/m²/day/bar . . . . For example, this layer is made of polyethylene which allows for simplified welding, the addition of organoleptic properties, the addition of moisture barrier properties, and ease of implementation. The layer 1 is composed of an oxygen barrier resin such as, for example, an ethylene vinyl alcohol resin. The active barrier layer 2 is, for example, a layer of polyethylene containing oxygen absorbers.

The addition of thin layers of binder between the layers in order to improve the cohesion of the structure is not described systematically in this explanation. This variant is difficult to obtain by injection in multi-impression molds because of the large number of layers. However, this variant can be obtained easily by compression molding using a co-extruded multilayer dose. In order to avoid complicating the explanation, the layers of binder are not described systematically, bearing in mind that a person skilled in the art knows when these layers have to be added.

A third embodiment of the invention consists of a structure comprising at least one passive barrier layer captive between two active barrier layers 2; said active barrier layer 2 being composed of oxygen absorbers dispersed in a first resin and the passive barrier layer 1 being composed of a second resin of oxygen permeability at least 50 times lower than that of said first resin.

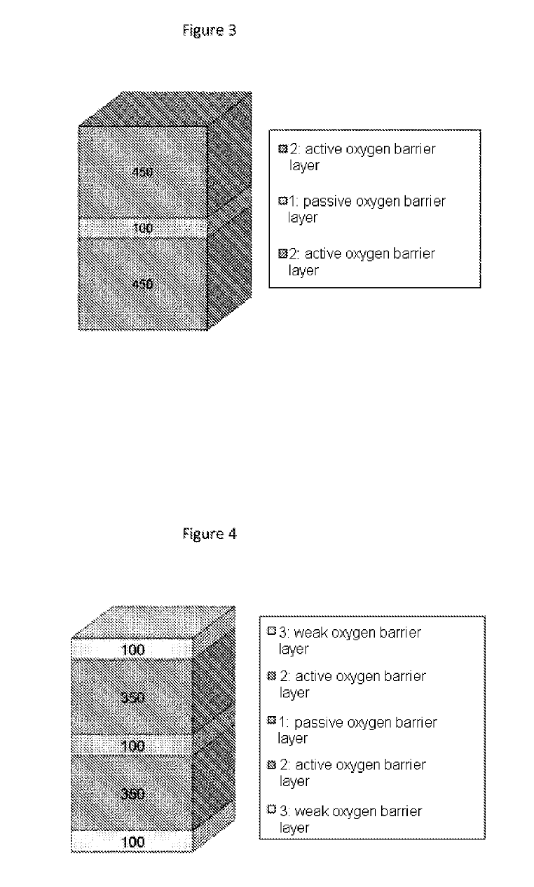

A sixth example related to the second embodiment of the invention leads to a multilayer structure of the 2/1/2 type illustrated in FIG. 3. This second embodiment is advantageous when the packaging comprises assembled parts. When the assembly is done on the outer surface of the molded object, it is advantageous to have oxygen absorbers also in the layer forming the outer surface of the packaging. The permeability of the welded area is thus greatly reduced. Such is the case, for example, with the necks of bottles that have a sealing area with a stopper on the outer surface. Such is the case also with the necks which are welded onto flexible pockets and for which the seal-tightness of the welding area is very significantly improved.

A seventh example relating to the second embodiment of the invention is illustrated in FIG. 4 and corresponds to a structure comprising the five successive layers 3/2/1/2/3. The neutral layers on the surface make it possible to improve the esthetic properties of the packaging and avoid direct contact between the oxygen absorbers and the packaged product.

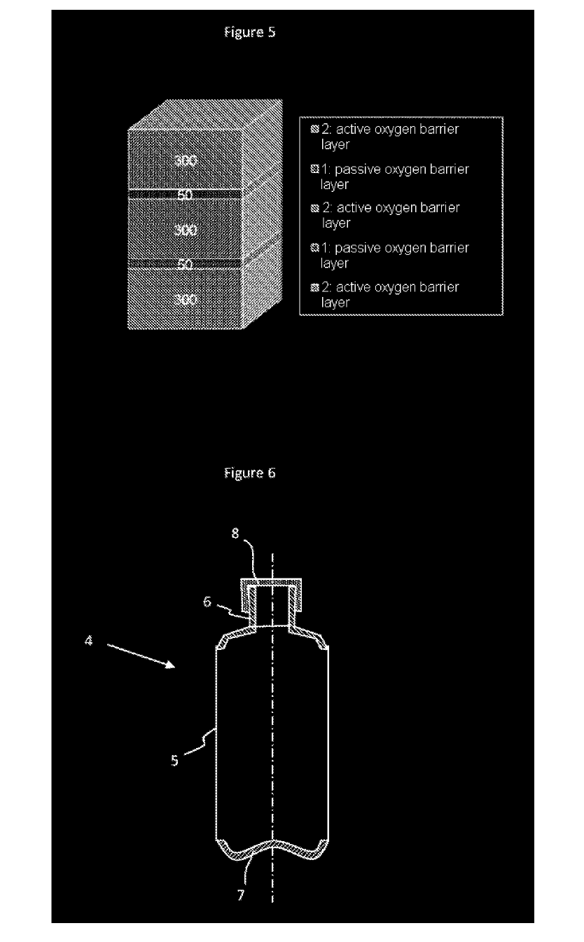

An eighth example is a combination of the first and second embodiments of the invention. This example illustrated in FIG. 5 consists of a structure comprising the successive layers 2/1/2/1/2. This structure is particularly interesting when the objects manufactured according to the invention are linked to another multilayer structure fashioned out of films. Such is the case, for example, with the flexible packaging tubes which comprise a flexible tubular body and a molded shoulder. The assembly of the shoulder and the tubular body creates a discontinuity of the passive barrier layers between the tubular body and the shoulder. This discontinuity also results in a strong decrease in the oxygen permeability of the packaging, a problem that the invention makes it possible to remedy. Other examples have been produced with the 375 ml bottle 4 illustrated in FIG. 6. The bottle 4 is composed of a flexible body 5, a neck 6, a bottom 7 and a stopper 8. The flexible body 5 is formed from a multilayer structure comprising a 12-micron layer of aluminum. This 0.3 mm thick flexible body 5 also comprises layers of polypropylene and is manufactured by welding. The oxygen impermeability of the flexible body is almost total by virtue of the layer of aluminum captive in the multilayer structure. The neck 6 and the bottom 7 also comprise a multilayer structure. The present invention is used to improve the oxygen impermeability of the neck 6 and of the bottom 7. The stopper 8 could also have a multilayer structure as described in the invention. For practical reasons, commercially available stoppers have been used. These stoppers 8 have a seal at the interface with the neck 6. This seal, also called liner, ensures the seal-tightness between the neck and the stopper and guarantees a weak oxygen permeability of the stopper by virtue of a barrier material situated in said seal.

Several versions of the bottle 4 have been produced by varying the multilayer structure of the neck 6 and of the bottom 7 and correspond to the examples respectively denoted 9 to 13. The multilayer structure of the neck 6 and of the bottom 7 has been produced with the following materials:
layer 1: polypropylene with 15% oxygen absorber
layer 2: ethylene vinyl alcohol
layer 3: polypropylene

The oxygen barrier properties of the bottles are compared by measuring the time it takes for the liquid contained by the bottle to receive 5 ppm (parts per million) of oxygen. These measurements are conducted in a laboratory according to a rigorous measurement protocol. A Presens laboratory appliance is used to quantify the quantity of oxygen which migrates in the packaging. The results of these measurements are summarized in the table below:

Time (days) for 5 ppm O2 to pass in the packaging

| | | | | O2 |
|---|---|---|---|---|
| | | | Thickness | absorbers |
| ppm O2 | Structure | Time | Microns | (%) |
| Example 9 | 3/1/3 | 7 days | 450/100/450 | 0 |
| Passive | | | | |
| barrier only | | | | |
| Example 10 | 2 | 32 days | 1000 | 10 |
| Active | | | | |
| barrier only | | | | |
| Example 11 | 2/1/2 | 331 days | 450/100/450 | 10 |
| Example 12 | 2/1/2/1/2 | 237 days | 300/50/300/50/300 | 10 |
| Example 13 | 1/2 | 619 days | 100/900 | 10 |

The examples 9 and 10 correspond to the prior art and serve as a reference.

The example 9 illustrates the properties of the bottle when the neck 6 and the bottom 7 comprise a multilayer structure with only a passive barrier. The time for 5 ppm of oxygen to migrate into the packaging is 7 days.

The example 10 corresponds to the properties of the bottle 4 when the neck 6 and the bottom 7 are composed of a single layer containing oxygen absorbers. The time for 5 ppm of oxygen to migrate into the bottle is 32 days.

The example 11 corresponds to the properties of the bottle 4 when the neck 6 and the bottom 7 comprise a passive barrier layer captive between two active barrier layers. This multilayer structure is illustrated in FIG. 3. The time for 5 ppm of oxygen to migrate into the packaging is 331 days. The product conservation time in this bottle is improved by a factor of 10 compared to the prior art bottle described in the example 10, and by a factor of 47 compared to the prior art bottle described in the example 9.

The example 12 illustrates the properties of the bottle 4 when the neck 6 and the bottom 7 comprise the five-layer structure illustrated in FIG. 5. The time for 5 ppm of oxygen to migrate into this bottle is 237 days. The product conservation time in this bottle is increased by a factor of 7 compared to the prior art bottle described in the example 10, and by a factor of compared to the prior art bottle described in the example 9.

The example 13 describes the properties of the bottle 4 when the neck 6 and the bottom 7 comprise a passive barrier layer 1 and an active barrier layer 2, the active barrier layer being situated inside the packaging. The time for 5 ppm of oxygen to migrate into this bottle is 619 days. The product conservation time in this bottle is increased by a factor of 19 compared to the prior art bottle described in the example 10, and by a factor of 88 compared to the prior art bottle described in the example 9.

The multilayer structure described in the example 13 is particularly powerful but, however, difficult to produce by multi-material molding. In practice, for economic reasons it is important to reduce the thickness of the passive barrier layer 1, which is difficult when the layer 1 is produced by injection or compression molding. There are, however, alternative techniques that make it possible to obtain this two-layer structure economically. A first alternative consists in overmolding a film containing the passive barrier with a resin comprising oxygen absorbers. This technology is limited to relatively simple object geometries. A second alternative consists in molding a multilayer object with a resin containing oxygen absorbers and then subsequently depositing a coating which adds a passive barrier to the surface of the molded object. Numerous coatings are known in the prior art such as, for example, the thin layers obtained by plasma deposition or gaseous phase evaporation. According to these methods, the passive barrier layer is generally either of the silicon or aluminum oxide type, or of amorphous carbon type.

The invention is not limited to the abovementioned examples and materials listed. There are a wide variety of resins or materials that can be used to form the passive barrier layer. In general, it is considered that the material can be used as passive barrier when its oxygen permeability value is at least 50 times lower than that of the material in which oxygen absorbers are added to form an active barrier layer.

Similarly, there are a wide variety of oxygen absorbers. The oxygen absorbers can, for example, be organic polymers which operate through iron oxidation, ascorbic acid or a polyamide catalyzed by cobalt; these products are standard on the market. In the invention, the term active layer is used for a layer containing at least elements which react with oxygen in order to limit the migration of the oxygen molecules into the packaging. In some products, the oxygen absorbers are associated with a barrier material which is dispersed in the form of slivers in order to increase the effectiveness by increasing the tortuousness.

As explained previously, the invention makes it possible to considerably improve the barrier properties of the parts molded by injection or compression molding. However, while working on developing the invention, the inventors observed that the oxygen impermeability of the packaging could be further improved by also applying the invention to other parts of the packaging.

When the packaging is a flexible tube, the inventors observed that the oxygen impermeability of the packaging was improved by applying the invention not only to the head of the tube as explained previously, but also to the tubular body. When the tubular body is co-extruded, oxygen absorbers can be incorporated in the most permeable layer in order to obtain multilayer structures as described in the invention. Other flexible tubes are obtained from a multilayer film which is welded on itself to form the cylindrical body. While this multilayer film is being manufactured by lamination or by co-extrusion, oxygen absorbers are added in order to obtain a multilayer structure as described in the invention.

It was observed that, when the packaging is formed from several parts, including at least one molded part, it is advantageous to apply the invention not only to the molded part but also to the other parts of the packaging. Such is the case in particular with packagings formed from films and including a neck, blown extruded packagings comprising a stopper, or even packagings having a cardboard-based multilayer structure and comprising a molded neck.

It should finally be pointed out that the invention can also be used in packagings formed from multilayer films or formed from any other multilayer structure not necessarily comprising one or more molded parts.

1. A multilayer structure obtained by molding and intended to form at least a part of the wall of a package; said structure comprising an oxygen barrier layer, called “passive layer”, composed of an oxygen barrier resin and another layer, called “active layer”, composed of at least one oxygen permeable resin in which oxygen absorbers are dispersed.

2. The multilayer structure as claimed in claim 1, comprising another passive layer, said active layer being situated between the two passive layers.

3. The multilayer structure as claimed in claim 1, comprising another active layer, said passive layer being situated between the two active layers.

4. The multilayer structure as claimed in claim 2, comprising the following successive layers: active-passive-active-passive-active.

5. The multilayer structure as claimed in claim 1, comprising a so-called neutral oxygen permeable layer.

6. The multilayer structure as claimed in claim 5, comprising the following successive layers: neutral-passive-active-passive-neutral.

7. The multilayer structure as claimed in claim 5, comprising the following successive layers: neutral-active-passive-active-neutral.

8. The multilayer structure as claimed in claim 1, in which the active layer is a layer of polyethylene containing oxygen absorbers.

9. The multilayer structure as claimed in claim 1, in which the passive layer is a layer of ethylene vinyl alcohol.

10. The multilayer structure as claimed in claim 5, in which the neutral layer is a layer of polyethylene.

11. A tube element comprising a structure as claimed in claim 1, said element being a tube head, a stopper, a bottom or a skirt.

12. A package comprising a first element manufactured as claimed in claim 1 and a second element which is not obtained by molding and comprising an oxygen barrier layer, called “passive layer”, composed of an oxygen barrier resin and another layer, called “active layer”, composed of at least one oxygen permeable resin in which oxygen absorbers are dispersed.

13. A package comprising a multilayer structure as claimed in claim 1 and a space intended to contain a product, said active layer being situated between the passive layer and said space.

14. A package comprising a multilayer structure as claimed in claim 1 and a space intended to contain a product, said passive layer being situated between the active layer and said space.
